(19) United States
(12) Patent Application Publication
(10) Pub. No.: US 2008/0014929 A1
(43) Pub. Date: Jan. 17, 2008

(54) OCCASIONALLY CONNECTED COMPUTING FOR MOBILE WEB SERVICES

(75) Inventors: Srinivas Padmanabhuni, Bangalore (IN); Abhishek Chatterjee, Kolkata (IN); Terance Dias, Pardi (IN); Geo Philips Kuravakal, Aranmula (IN); Varun Poddar, Chakradharpur (IN)

Correspondence Address: KLARQUIST SPARKMAN, LLP, 121 SW SALMON STREET, SUITE 1600, PORTLAND, OR, 97204, US

(73) Assignee: Infosys Technologies Ltd., Bangalore (IN)

(21) Appl. No.: 11/735,932

(22) Filed: Apr. 16, 2007

(30) Foreign Application Priority Data
May 5, 2006 (IN) 811/CHE/2006

(51) Int. Cl. H04Q 7/20

(52) U.S. Cl. 455/432.1

(57) ABSTRACT

Reliable messaging can be incorporated into a framework for occasionally connected computing (OCC). For example, various delivery assurance profiles can be supported for an application accessing Web Services to accomplish online business processing. Processing can be accomplished transparently with respect to whether the Web Services are available to a mobile computing device.

### BACKGROUND

Mobile devices use wireless networks that have a limited range. So, they may not always be connected to a network. Such intermittent connectivity in mobile devices can inhibit enterprise-level adoption of pervasive mobile applications. Occasionally connected computing (OCC) technologies deal with intermittent connectivity problems.

Another challenge facing mobile application developers is developing applications that will allow users to interface uniformly with the application, regardless of the connection status.

A technology that can be used by mobile platforms is Web Services. However, use of Web Services for occasionally connected mobile applications can fall flat because of a lack of reliability.

Therefore, there still remains need for techniques to address reliability in occasionally connected computing scenarios.

### SUMMARY

A variety of techniques can be used for achieving reliability in occasionally connected computing scenarios. For example, when a request is received to perform an online business process via a Web Service, one or more messages can be sent to the Web Service via reliable messaging. For example, a reliable messaging infrastructure can be used to send one or more messages to the Web Service.

As described herein, a variety of other features and advantages can be incorporated into the technologies as desired.

The foregoing and other features and advantages will become more apparent from the following detailed description of disclosed embodiments, which proceeds with reference to the accompanying drawings.

### BRIEF DESCRIPTION OF THE FIGURES

FIG. 1 is a block diagram of an exemplary system implementing reliable messaging in a Web Services scenario.

FIG. 2 is a flowchart of an exemplary method of processing a request to perform an online business process via reliable messaging to a Web Service and can be implemented in a system such as that shown in FIG. 1.

FIG. 3 is a flowchart of an exemplary method of processing a request to perform an online business process via reliable messaging supporting both online and offline modes and can be implemented in a system such as that shown in FIG. 1.

FIG. 4 is a block diagram illustrating reliable message delivery.

FIG. 5 is a block diagram of a system implementing reliable messaging in a Web Services scenario for a variety of client machine types.

FIG. 6 is a block diagram of a framework by which reliable messaging can be accomplished by a client application in an occasionally connected computing scenario.

FIG. 7 is a flowchart of an exemplary method of processing a request for an online business process that uses reliable messaging in a Web Services environment.

FIG. 8 is a flowchart of an exemplary method of providing reliable message delivery.

FIG. 9 is a block diagram of an exemplary suitable computing environment for implementing any of the technologies described herein.

### DETAILED DESCRIPTION

### Example 1

### Exemplary System Employing a Combination of the Technologies

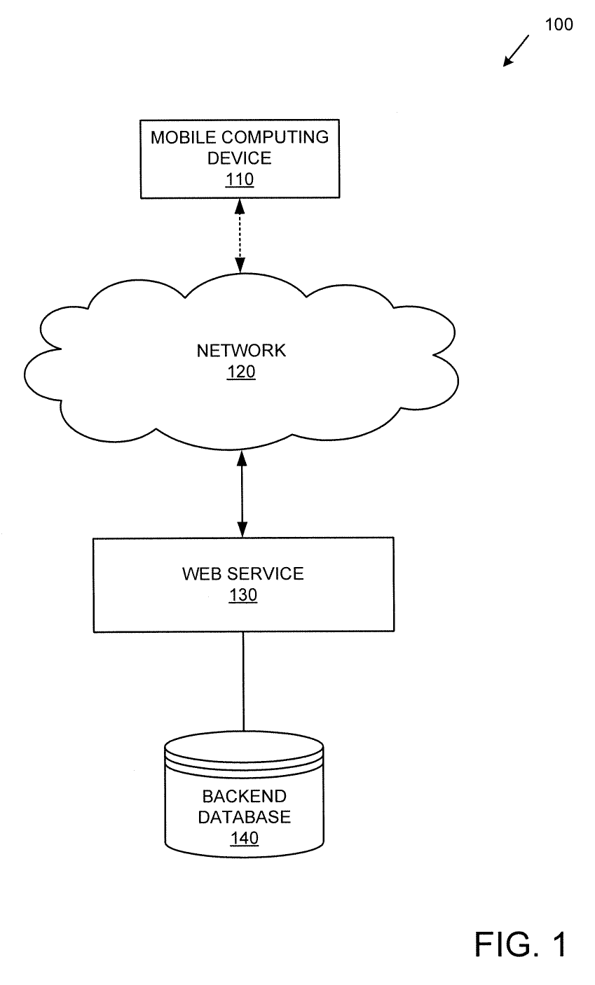

FIG. 1 is a block diagram of an exemplary system 100 implementing reliable messaging in a Web Services scenario. The system 100 and variants of it can be used to perform any of the methods described herein.

In the example, the system 100 includes a mobile computing device 110, that communicates through a network 120 to a Web Service 130, which can update one or more backend databases 140.

In practice, the system 100 can be more complicated, with additional devices, networks, services, databases, and the like.

### Example 2

### Exemplary Mobile Computing Devices

In any of the examples herein, a mobile computing device can include any of a variety of computers, phones (e.g., common mobile phones, Smartphones, and the like), personal digital assistants (PDAs), small form factor tablet PCs, hand-held electronics, or other computing devices that are intended to be mobile. Laptop and notebook computers can be mobile computing devices that are carried from location to location by a user.

The technologies are particularly applicable to scenarios in which the mobile computing device 110 is sometimes disconnected from (e.g., unable to access) the network 120 in what is sometimes called an “occasionally connected computing” scenario. Such a situation can arise in a wired or wireless scenario. For example, in a wireless scenario, the mobile computing device 110 may depend on wireless connectivity to the network 120, which is not guaranteed, depending on the physical location of the networkable device 110.

In a wired scenario, the mobile computing device 110 may depend on a physical connection to the network 120, which is not guaranteed, such as when a laptop computer is disconnected from a network for mobility.

In fact, the technologies can be used even if the connection is available but not connected for some reason (e.g., limited bandwidth, cost, etc.).

Of course, mobile computing devices 110 can support both wired and wireless connections, but may still be disconnected from the network 120 because neither method currently provides a connection.

In any of the examples herein, a mobile computing device can be used as a client device and can take the form of an electronic device that can generate a request for processing and receive a response to the request. There is a virtually unlimited number of different mobile computing device types, with others expected to be developed in the future. The technologies described herein can support mobile computing devices running on a wide variety of platforms, including a mixture of device types, platforms, or both.

### Example 3

### Exemplary Networks

In any of the examples herein, a network can be any electronic communications network allowing a computing device to access a Web Service. Such networks include public (e.g., the Internet) and private (e.g., an intranet) networks. Wireless, wired, and hybrid networks can be supported.

### Example 4

### Exemplary Web Service

In any of the examples herein, a Web Service can provide a software service to client devices that access the service via a network. For example, the Web Service can take the form of an API or other interface by which a client device can access the service.

In practice, a client passes parameter data with a request to the Web Service, which results in a response having results provided by the Web Service.

### Example 5

### Exemplary Perspectives

Although some of the examples assume the perspective of a client device (e.g., by calling it “local”), the technologies described herein can be implemented from other perspectives (e.g., from the perspective of the Web Service, the network, and the like). For example, although the terminology “sending a message to a Web Service” is used from the perspective of a client device, such an act could also be described as “receiving a message from a client device” from the perspective of the Web Service.

### Example 6

### Exemplary Backend Database

In any of the examples herein, a backend database can be any store of data used by a Web Service to respond to requests. For example, such a database can store information about resources related to conducting business (e.g., customer data, product data, order data, expense data, inventory data, and the like).

### Example 7

### Exemplary Method Employing a Combination of the Technologies

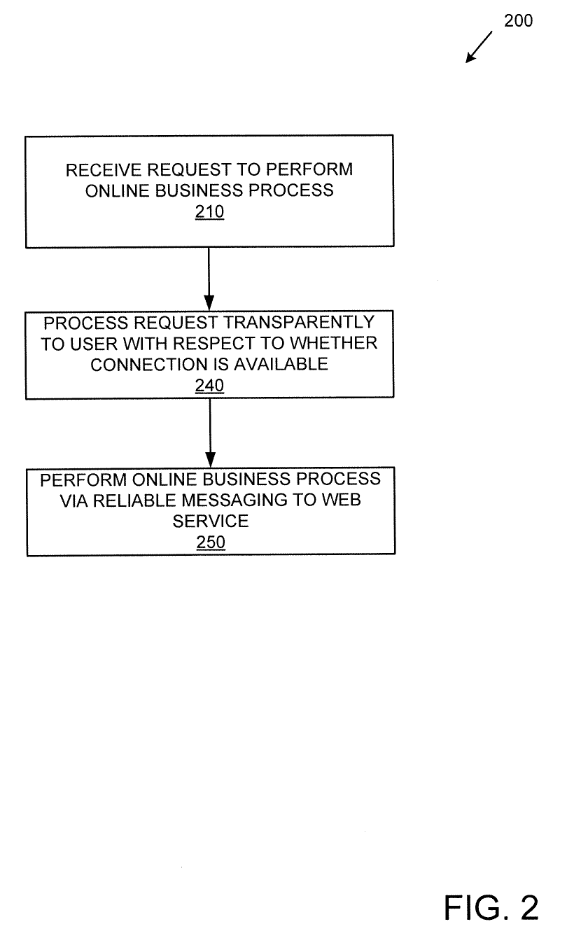

FIG. 2 is a flowchart of an exemplary method 200 of processing a request to perform an online business process via reliable messaging to a Web Service and can be implemented in a system such as that shown in FIG. 1.

At 210, a request is received on a mobile computing device to perform an online business process. For example, the request can be received by a client application running on a mobile computing device. Such a request can take the form of a command by a user using the client application. For example, information (e.g., values) for performing the online business process can be received from a user via a user interface on the mobile computing device. The request can be initiated by an indication by the user on the user interface (e.g., activating an “OK” or “Send” user interface element).

At 240, responsive to receiving the request, the request is processed transparently to the user with respect to whether a connection to the Web Service (e.g., to the network) is available (e.g., whether a response is available). Thus, the process can be processed in such a way that it appears to the user that the mobile computing device is connected to the Web Service, even if the device is not connected. As described herein, processing the request can include sending a message via an “at most once” delivery assurance profile.

At 250, the online business process is performed via reliable messaging to the Web Service. One or more messages can be sent to the Web Service via reliable messaging, but they may not be received for some time. For example, even if the mobile computing device is not connected to the Web Service, a reliable messaging infrastructure can guarantee eventual delivery of the message to its destination (e.g., upon re-connection to the network). As described herein, such messages can be sent to the Web Service via an “exactly once” delivery assurance profile.

Receipt of the message by the Web Service achieves performance the online business process (e.g., updates remote databases, initiates one or more other business processes, and the like). In addition to the one or more messages that are received, some messages sent via reliable messaging need not be received (e.g., those sent with an “at most once” delivery assurance profile).

The method 200 and any of the methods described herein can be performed by computer-executable instructions stored in one or more computer-readable media (e.g., storage or other tangible media). Such instructions can cause a computing device to perform the actions of the method.

### Example 8

### Exemplary Method with Online and Offline Modes

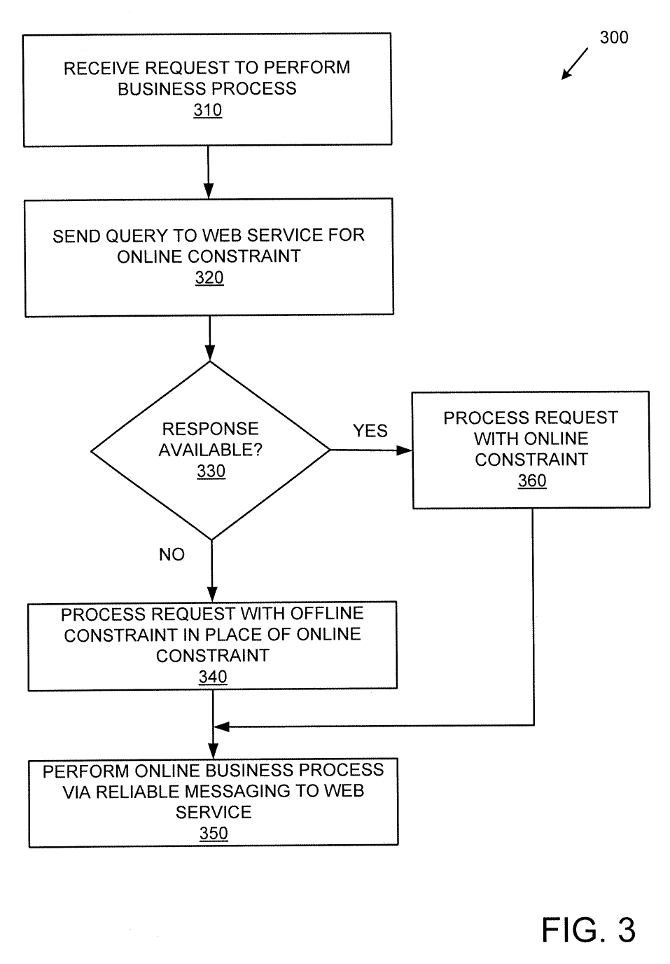

FIG. 3 is a flowchart of an exemplary method of processing a request to perform an online business process via reliable messaging supporting both online and offline modes and can be implemented in a system such as that shown in FIG. 1. The method can be implemented similar to that shown in FIG. 2. For example, processing a request transparently (e.g., the actions of 240) can be implemented as 320-360 shown in FIG. 3.

At 310, a request to perform an online business process is received (e.g., similar to that of 210 of FIG. 2).

At 320, a query is sent (e.g., attempted to be sent) to a Web Service for an online constraint. Such an online constraint can be a value that affects how the business process is processed by the client application. For example, the online constraint can be related to inventory (e.g., number of items remaining), budget (e.g., remaining funding), or the like. As described herein, such a query can be sent via an “at most once” message delivery assurance profile.

At 330, it is determined whether a response is available (e.g., whether the Web Service is available to the client application via a network connection). If no response is available, the request is processed with an offline constraint in place of the online constraint at 340.

If a response is received, at 360, the request is processed with the online constraint provided by the Web Service.

Processing the business process can include determining whether information submitted for accomplishing the business process violates the online or offline constraint. If so, a warning can be shown at the mobile computing device.

At 350, the online business process is performed via sending a message to the Web Service via reliable messaging (e.g., similar to 250).

### Example 9

### Exemplary Offline Constraints

In any of the examples described herein, an offline constraint can be used in place of an online constraint when a connection is not available. The offline constraint can be used during business process processing to give the appearance of being connected.

Like an online constraint, such an offline constraint can be related to inventory (e.g., number of items remaining), budget (e.g., remaining funding), or the like. Instead of an actual number, a quota (e.g., of allowable units) can be used. For example, a sales quota can be allocated for a salesperson in the field.

After processing the business process when there is no connection (e.g., in offline mode), the constraint can be updated (e.g., the sales quota reduced) or a running total can be stored for comparison to the constraint.

If it is detected that the offline constraint is violated (e.g., a quota is exceeded), a warning message can be displayed at the mobile computing device.

### Example 10

### Exemplary Online Business Processes

In any of the examples herein, a variety of online business processes can be supported. For example, online business processes can implement a wide variety of functionality related to placing product or service orders, placing supplier orders, requesting reports, submitting expenses, querying inventory, and the like.

The online business process can query, modify, or otherwise interact with one or more Web Services that provide access to data (e.g., stored in one or more databases) for the business process.

### Example 11

### Exemplary Client Applications

In any of the examples herein, the client application executing on the mobile computing device can be any of a variety of applications for performing various business processes. Such applications can also run on desktop machines. However, the client applications on mobile computing devices are sometimes called “mobile applications” because they can be adapted for use on mobile computing devices. In some cases, the client application can be tailored for the client device. For example, a mobile phone may have limited screen real estate or a specialized operating system, so the client application can be designed to accommodate such limitations.

Different versions of the same client application (e.g., different programs providing the same business process functionality) can appear on different types of mobile computing devices, all of which can work through a same Web Service, regardless of how they connect to the service.

### Example 12

### Exemplary Mobile Platforms

Mobile computing devices can vary significantly on hardware and software configurations. For the sake of example, some are discussed here, but others can be incorporated into the described technologies, and others are likely to be developed in the future. Most modern rich mobile devices can use one of the following operating systems:

1. Symbian OS is a popular Smartphone operating system. It is an Independent Open Source project. The OS is not found as such on devices but is customized according to the phone manufacturer's needs. For example, NOIKIA phones use a series of Symbian-based interfaces known as the S series (e.g., S60, S90), while SONY ERICSSON devices have UIQ platform interfaces. Symbian runs mainly J2ME applications and has a dedicated JAVA execution layer. Symbian is typically not found in PDAs without phone functionality.

2. The MICROSOFT WINDOWS CE operating system runs on a variety of mobile devices such as PDAs, Smartphones, and hybrids. The various versions of CE are given different names such as WINDOWS MOBILE 2002 and 2003, along with different editions of the same, such as POCKETPC, Smartphone, and POCKETPC phone. One version is WINDOWS MOBILE 5.0. WINDOWS CE can use the .NET CF platform for development.

3. The PALMOS operating system can also be found in many mobile PDAs and phones, such as the popular TREO line of devices. Being the first dedicated mobile OS, it has a huge library of applications. Coding can be done primarily in C/C++.

4. Other operating systems, such as Linux and its embedded versions can be found in specialized devices. BLACKBERRY devices use a proprietary operating system.

At the language level, most of these devices natively support either the JAVA or .NET platform as a mobile language platform.

1. JAVA is implemented on mobile devices using the JAVA 2 Microedition (J2ME) platform. Programs written for J2ME are similar to normal JAVA programs, except that they have smaller libraries and are written for a more compact virtual machine.

2. Microsoft Corporation's .NET Compact Framework (.NET CF) for mobile devices lets developers program for devices that run the WINDOWS CE operating system versions such as POCKETPCs and WINDOWS MOBILE Smartphones. Integrated into the popular VISUAL STUDIO toolset, it has an intuitive and easy-to-use GUI to build and test mobile applications as well as excellent native XML support.

3. Other languages such as C/C++ are also supported on some operating systems, such as Symbian, PALM, and BLACKBERRY operating systems.

The diversity in application platforms as detailed above can pose serious interoperability problems and is a cause of the high cost involved in developing enterprise mobility applications.

Support for open standards like Web Services can be included in these mobile platforms. This can be an enabler of interoperability across diverse mobile platforms and of enterprise mobility applications that can be treated as extensions of conventional enterprise applications exposed via services to mobile devices. Support for Web Services is found in the following platforms:

1. .NET CF offers native support for calling and handling Web Services, as well as complete XML processing capabilities, such as support for XML schemas, Xpath, and XML serialization. Due to the integrated nature of the framework and full support for SOAP and other protocols, the Web Service support in the CF is well-rounded and simulates functionality available on larger devices.

2. The J2ME platform also supports Web Services. Basic Web Service clients can be made using the JAVA SOAP toolkit. And, such functionality is natively available in J2ME via Sun's JSR-172, which aims to provide access to remote SOAP- and XML-based Web Services and to provide XML parsing capability in J2ME. Frameworks such as kSOAP and MIC can be used.

### Example 13

### Exemplary Reliable Messaging

In any of the examples herein, messages can be processed (e.g., sent) by a mobile computing device according to a reliable messaging scenario. For example, a reliable messaging infrastructure or standard can be implemented at the client mobile computing device to ensure that a message is delivered to its destination.

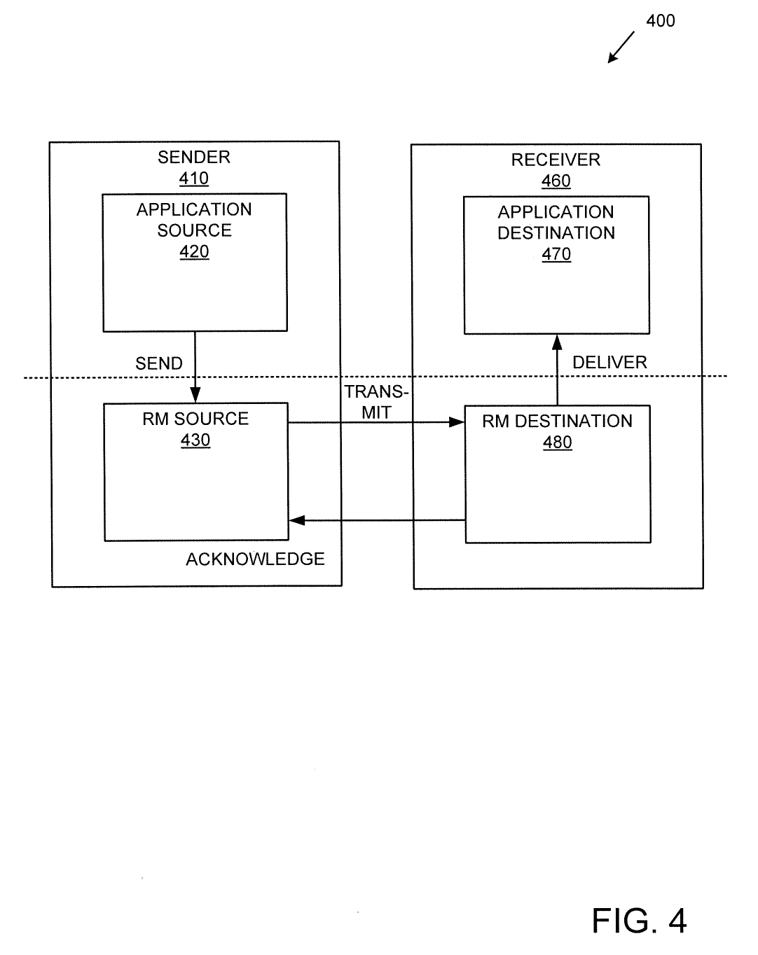

FIG. 4 is a block diagram illustrating reliable message delivery. In the example, a message starts at a sending mobile computing device 410 with an initial sender, the application source 420, which sends the message for reliable delivery. The reliable messaging source 430 accepts the message and transmits it one or more times to a reliable messaging destination 480, which acknowledges receipt of the message after receiving it. The reliable messaging destination 480 delivers the message to the ultimate receiver, the application destination 470 on a receiving machine 460.

As described herein, transmission can be done over a network that is occasionally connected. The reliable messaging infrastructure (e.g., shown below the dotted line) can assume responsibility for reliable delivery of the message, including determining when a message is not acknowledged and attempting to resend. If no connection is available, the reliable messaging infrastructure can determine when a connection is available and attempt delivery of any unacknowledged messages. In some cases, it may be possible for the infrastructure to determine that there is no connection and simply wait until a connection is available. Whatever technique is used need not be of concern to the initial sender, the application source 420, which delegates responsibility for reliable messaging to the infrastructure.

### Example 14

### Exemplary Reliable Messaging Infrastructures

In any of the examples herein, a variety of reliable messaging infrastructures can be used to achieve the technologies. The infrastructure can be implemented as a module, procedure, function, or the like in a client application on the mobile computing device or shared by a plurality of client applications. The same infrastructure can be used by different parts of the client application (e.g., once to query a Web Service, then once to complete the business process, and the like).

The reliable messaging infrastructure can handle the details of reliable message delivery. For example, the client application can pass messages to the infrastructure for delivery via reliable messaging.

An infrastructure implementing the Web Services Reliable Messaging (WS-ReliableMessaging or WSRM) specification of Microsoft Corporation, BEA Systems, Tibco Software, and IBM can be implemented, optionally including changes by the OASIS organization. The specification ensures that the Web Service message actually reaches the Web Service receiver and is not lost in transit.

Similarly, the infrastructure can implement the WS-Reliability standard protocol by the OASIS organization for reliable messaging.

### Example 15

### Exemplary Message Delivery Assurance Profiles

In any of the examples herein, when a message is sent (e.g., via the reliable messaging infrastructure as described), a delivery assurance profile specifying the type of delivery assurance can be included with the message. For example, when passing the message to the reliable messaging infrastructure, a parameter specifying the delivery assurance profile type can be included. Possible delivery assurance profiles include “exactly once” (e.g., “once and only once”) delivery and “at most once” delivery.

A basic form of a reliable messaging is the delivery assurance profile “exactly once.” To implement such a profile, the sender may store the message before sending it across to the receiver and delete it only when it gets an acknowledgement from the receiver. If the receiver fails to acknowledge the message, it is assumed to be lost and is re-sent.

The “at most once” delivery assurance profile specifies trying to reach the Web Service just once. If it fails, the message can be lost. Although this appears to defeat the purpose of having reliable messaging, it can be quite useful as described herein.

Another possible profile is “at least once.”

### Example 16

### Exemplary Transparency With Respect to Whether Connection is Available

In any of the examples herein, processing can be done transparently to whether a connection to a network or Web Service is available to the client mobile computing device. For example, if a set of user interfaces is presented when processing a business process when there is a connection (e.g., when online), the same set of user interfaces can be presented when there is not a connection (e.g., when offline). The same user interface can be presented for processing an online business process, regardless of whether or not the mobile computing device is connected to a network (e.g., in an offline mode).

For example, when the online business process has been performed when online, a user interface can be presented indicating that the business process has been performed. The same user interface can be presented regardless of whether or not the mobile computing device is connected to a network.

If desired, some minor changes can be incorporated into the user interfaces to indicate that offline processing is taking place or that offline constraints are being used. However, the same input can be accepted and seemingly same output values can be provided during offline mode (e.g., on the same user interface screens as those used for online processing).

### Example 17

### Exemplary System Implementing Reliable Messaging in a Web Services Scenario

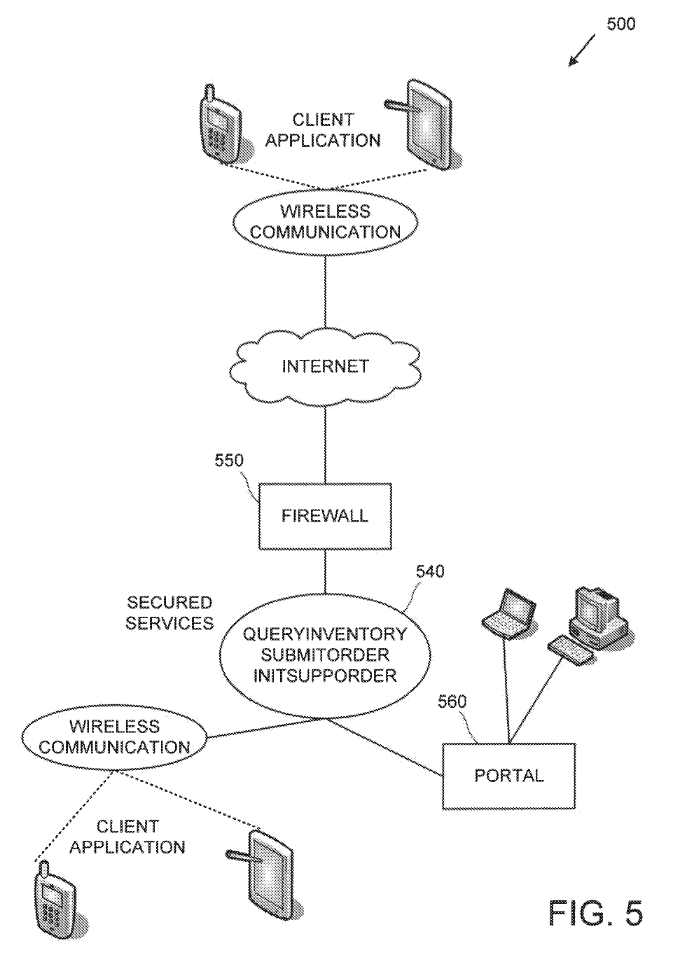

In any of the examples herein, the technologies can be implemented into a system that provides a variety of connectivity options. FIG. 5 is a block diagram of a system 500 implementing reliable messaging in a Web Services scenario for a variety of client machine types.

In the example, a variety of client machines types can connect to secured services 540. In the example, the secured services 540 include one or more Web Services (e.g., Query Inventory, Submit Order, and Initialize Supplier Order). In addition to wireless communication connectivity inside and outside a firewall 550, some clients can connect via a portal 560 (e.g., a web site). Thus, the mobile computing device can share the Web Services 540.

### Example 18

### Exemplary Framework for Client Application

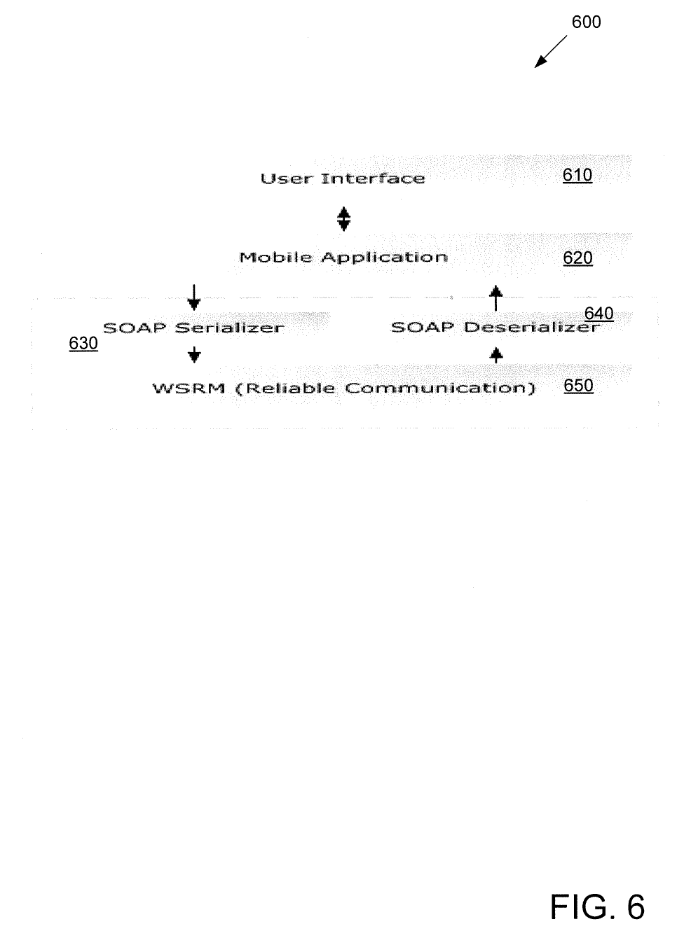

In any of the examples herein, reliable messaging can be implemented by a client application (e.g., executing on any of the client devices described herein). FIG. 6 is a block diagram 600 of a framework by which reliable messaging can be accomplished by a client application 620 in an occasionally connected computing scenario and can be implemented in any of the mobile computing devices described herein.

The client application 620 can include a user interface 610 that allows the user to enter input data into the system 600. The client application 620 can let the user work and store data offline.

The client application 620 can handle the events generated by the user's interaction. It can also ensure that the application 620 works normally (e.g., transparently to the user, as if online) even if the device is not connected (e.g., in an offline mode). To accomplish transparency, the application 620 can keep its state information and cache content in the mobile device storage (e.g., depending on the scenario).

The application 620 can call the Web Service residing in a remote server using the SOAP serializer 630 and reliable messaging infrastructure 650 (e.g., WSRM component) shown.

The SOAP serializer 630 can create a SOAP request message as expected by the Web Service and send the message to the reliable messaging infrastructure 650 for reliable communication. The response (e.g., from the Web Service) is passed from the reliable messaging infrastructure 650 to the SOAP deserializer 640 to convert the SOAP response to an application-specific format.

The response message then goes to the mobile application 620. Depending on the response, the user interface 610 can be updated appropriately.

### Example 19

### Exemplary Reliable Messaging Reliability Levels

In any of the examples herein, reliability levels (e.g., delivery assurance profiles) can be used when sending messages. The reliable messaging infrastructure can ensure that the reliability level (e.g., exactly once, at most once, etc.) of the communication during the Web Service invocation is attained. Depending on the requirements of the application, the reliability level for the Web Service invocation can be set. In the case of a reliability level being set at “at most once,” the application can switch over to offline mode if a response is not available. It is also possible that the application may not have to have an offline execution mode. In such a case, the user can be kept oblivious of the connection status of the device, and the reliable messaging infrastructure can ensure that the Web Service is called whenever the connection is available.

### Example 20

### Exemplary Technologies for Use with Occasionally Connected Computing

In any of the examples herein, the Occasionally Connected Profile (OCCP) v0.1 can be applied. Those features resulting from the community process conducted by the Oasis organization can also be incorporated.

The Profile is noteworthy, but can have limitations, such as its requirement for a mobile database for persistence, its scope of coverage in terms of the range of mobile devices covered, and the like.

### Example 21

### Exemplary Method of Processing a Request for an Online Business Process with Reliable Messaging

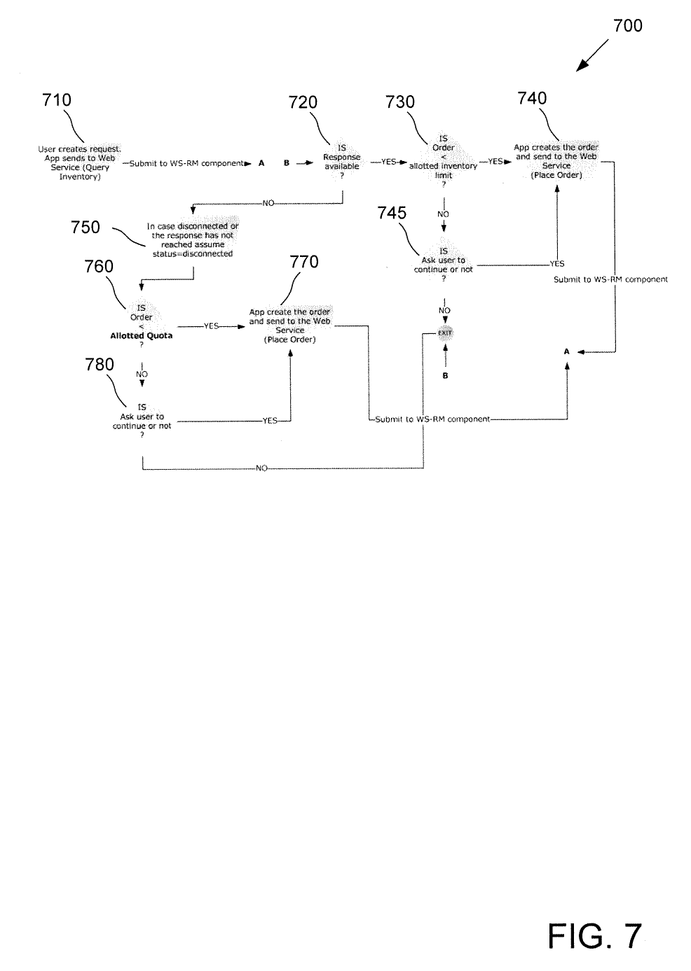

The technologies in any of the example herein can be applied to a variety of use cases. FIG. 7 is a flowchart of an exemplary method 700 of processing a request for an online business process (e.g., placing an order) that uses reliable messaging in a Web Services environment. This is an exemplary use case (e.g., placing an order) for the technologies described herein.

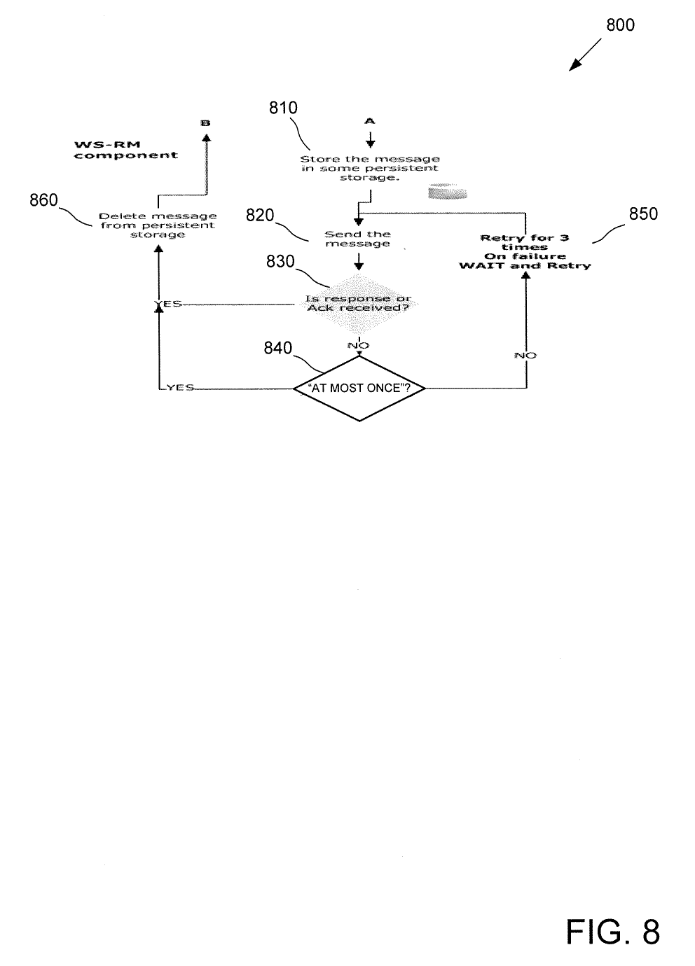

In the example, the flowchart shows a method 700 of a request process for placing an order (e.g., with a server via a Web Service). Two Web Services are used. The first one is the QueryInventory Web Service for checking the status of the inventory. This Web Service uses an “at most once” delivery assurance profile. So, if the WSRM component tries to send it once and it fails, it informs the application (e.g., as shown in FIG. 8). Depending on whether the response has arrived from the QueryInventory Web Service, the application decides whether to use the inventory value (the online constraint) or the quota (an offline constraint).

The second Web Service is for submitting the order information (i.e., the SubmitOrder Web Service). This Web Service uses the “exactly once” delivery assurance profile. Once the application has created the request, the reliable messaging infrastructure tries to send it; if it fails, it tries n times more (e.g., three times more) and then tries again after some specified wait period of time.

At 710, the user creates the request. For example, the user can use the user interface of the mobile computing device to enter in information for placing an order (e.g., one or more item quantities, buyer, and the like). The application responds by sending a message to the QueryInventory Web Service (e.g., to determine how much inventory remains). In the example, the message is submitted to the reliable messaging infrastructure via an “at most once” delivery assurance profile, and processing passes to FIG. 8.

At 720, if a response is available, it is checked at 730 whether the order is less than or equal to the allotted inventory limit (e.g., one or more quantities retrieved from the Web Service). If so, the application creates the order submission and sends it to the Web Service to actually place the order (e.g., submit the order information) at 740. An “exactly once” delivery assurance profile is used as processing passes to FIG. 8. Upon return, the method is finished and can be repeated as appropriate.

If the order was not within the allotted inventory limit, the application can provide a warning at 745 (e.g., asking the user whether or not to continue, providing a way to notify a manager, or the like). The user can abort the order at this time if desired.

If a response was not available at 720, it is assumed that the status is disconnected at 750 (e.g., this need not be an explicit act). Instead of the online constraint of the allotted inventory limit from the Web Service, an offline constraint (e.g., allotted quota) is used.

At 760 it is checked whether the order is less than or equal to the allotted quota (e.g., one or more quantities stored locally and available regardless of connection status). If so, an order is placed at 770 similar to that of 740. If not, a warning at 780 is provided similar to that of 745. The user can abort the business process at this time if desired.

Upon receipt of the message indicating the order, appropriate databases can be updated, the order fulfillment business process can be initiated, and the like.

In practice, other business processes can be developed using the method 700 as a guideline. Online and offline constraints can be used in conjunction with reliable messaging to provide a reliable messaging scenario for Web Services in an occasionally connected computing environment.

### Example 22

### Exemplary Reliable Message Delivery

In any of the examples herein, a reliable message delivery infrastructure can implement the logic for ensuring reliable messaging according to specified delivery assurance profiles.

FIG. 8 is a flowchart of an exemplary method 800 of providing reliable message delivery. In the example, “exactly once” and “at most once” are supported.

At 810, a message received by the infrastructure stores the message in persistent storage (e.g., a file, database, or the like at the mobile computing device).

At 820, the message is sent (e.g., an attempt to send the message is performed).

At 830, if a response or acknowledgement is received (e.g., sending the message was demonstrably successful), execution proceeds to delete the message from persistent storage at 860.

Otherwise, it is checked whether delivery assurance is “at most once” at 840. If so, execution proceeds to delete the message from persistent storage at 860.

Otherwise, “exactly once” delivery assurance was specified, and n retries are done at 850 until success is detected.

### Example 23

### Exemplary Application of the Methods

The methods shown in FIGS. 7 and 8 can be implemented as an architectural framework leveraging OCC. The methods can be implemented in an inventory management system in the context of a mobile sales force application and can address the ever-increasing need for connectivity in an enterprise for its mobile work force. The system can provide services such as submitting a customer order, querying the current inventory status, initiating the order process with a supplier to replenish inventory, and the like.

The services can cater to the needs of different kinds of users who can place a customer's order and view the inventory status: a field sales person who is on the move and has to access the services through a Smartphone (e.g., running a version of the SYMBIAN OS), a manager moving around with a POCKETPC device, an in-house sales person/manager/employee, who has a laptop or PC (e.g., a desktop computer) and can place a customer's order or order from the inventory supplier through the company portal (e.g., a web site), and the like

To make the services available to the different users, they are available as Web Services. Access to the portal can require that the devices be online (e.g., always online). But with mobile devices having intermittent connectivity, this is not always possible. So, these devices can have a client application installed through which they can access the Web Services. An arrangement such as that shown in FIG. 5 can be supported.

In any of the examples herein, access to the Web Services can be role-based, so that access is limited to those users defined as being in certain roles. For example, the salesperson can see the current inventory status and submit customer orders, whereas the manager has the extra privilege of initiating the order process with the supplier for refilling the stock.

In the example, it is assumed that the enterprise uses an optimistic approach for its sale process. Here, the salesperson will have a fixed quota out of the total stock in inventory. This will enable the salesperson to create and submit customer orders when not connected. In this case, the salesperson can create orders only within the allotted quota.

The client application lets the user submit orders as if online, and when connected again, the submitted orders will be sent to the central repository (e.g., back end database) and the order processing may start immediately. However, if connected, the real-time inventory status can be viewed and orders can be taken beyond the quota.

The decrease in inventory may result in triggering a re-order alert to replenish the inventory. The trigger will make the manager aware of the current inventory status so that the manager can initiate the re-order with the supplier. Thus, a balance can be maintained between the current stock and the customer orders. The manager can also initiate the re-order at discretion, market speculation, etc. The application can ensure that the order to the supplier is initiated even if the mobile device is not connected (e.g., at the time the order is entered) by using reliable messaging to send the request upon receiving connectivity transparently (e.g., without action by the user when re-connecting).

### Example 24

### Exemplary Implementation Details

The technologies described herein can be implemented via MICROSOFT's .NET framework 2.0 running on IIS 5.1 to implement Web Services. To work with WSRM messages, Web Service Enhancements (WSE) 3.0 can be used.

On the client side, a SYMBIAN Smartphone running J2ME and a POCKETPC machine running .NET Compact Framework can be used. To persist the data on the client side, files can be used. However, other techniques (e.g., a database, if such functionality is supported) can be used.

For example, the WSRM component of the client application installed on the mobile devices can create the WSRM-compliant messages and store them in files. The application can resend the messages in case of failure. The WSRM component can take care of the “exactly once” and “at most once” delivery assurance depending on a configuration file associated with the respective Web Service.

### Example 25

### Exemplary Framework and Contributing Technologies

Despite the inherent occasionally connected nature of mobile devices, architectures can be devised to enable enterprise-level mobile applications. Two key contributing technologies to do so can include at the core a Web Services-based framework that is predicated on the support of Web Services in most mobile platforms. Further, for reliability, a framework based on WSRM to handle the occasionally connected problem in mobile Web Services can be used.

WSRM can be used for reliable messaging, even though it is not yet an Oasis standard. Alternatively, WS-Reliability can be used for reliable messaging, which is currently an Oasis standard. WSRM can be consistent with other WS-* standards.

### Example 26

### Exemplary Alternative Technology

In any of the examples herein, reliable messaging can be implemented according to WS-Reliability. WS-Reliability is a SOAP-based specification that fulfils reliable messaging requirements for Web Services. The specification defines reliability in the context of Web Services standards.

### Example 27

### Exemplary Alternative Technologies

In any of the examples herein, ad-hoc mechanisms for reliable messaging of Web Services can be used, such as SOAP over message queues (MICROSOFT Message Queue or JAVA Messaging Service) instead of WSRM.

Message queues can provide an asynchronous communication protocol, meaning that the sender and the receiver of the message do not need to connect to the message queue at the same time. Messages placed onto the queue can stay there in stored form until the recipient retrieves them.

Implementations of message queues can function internally: within an operating system or with in an application. Such queues can exist for the purposes of the system only. Other implementations can allow the passing of messages between different computer systems, potentially connecting multiple applications and multiple operating systems. Such message queuing systems can provide enhanced resilience functionality to ensure that messages are not lost in the event of a system failure. For example, MICROSOFT Message Queue (MSMQ) or the JAVA Messaging Service (JMS) can be used for reliable messaging.

Sending SOAP messages over such queues can result in a persistent storage for the messages which is deleted only after the message has been delivered and the acknowledgment is received.

### Example 28

### Exemplary Computing Environment

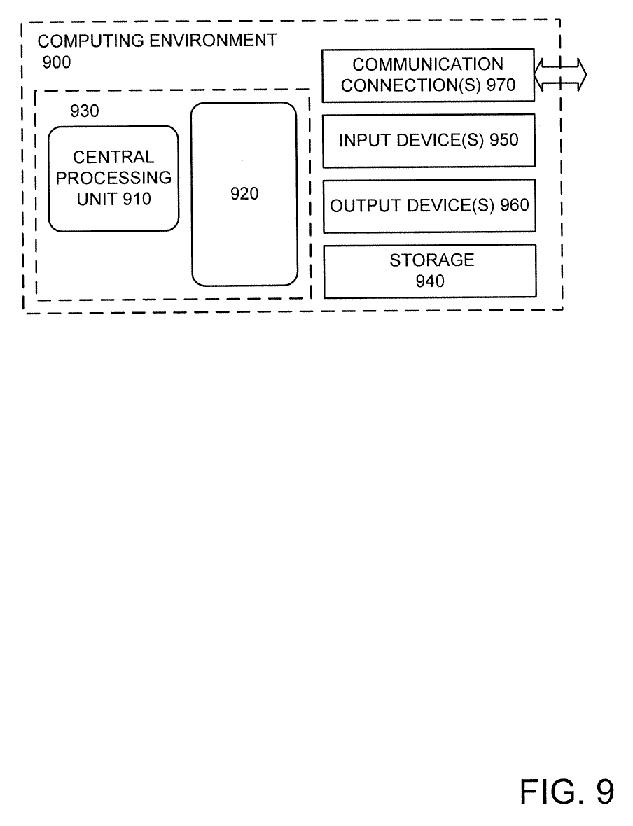

FIG. 9 illustrates a generalized example of a suitable computing environment 900 in which the described techniques can be implemented. The computing environment 900 is not intended to suggest any limitation as to scope of use or functionality, as the technologies may be implemented in diverse general-purpose or special-purpose computing environments. Mobile computing devices can similarly include computer-readable media. A mainframe environment will be different from that shown, but can also implement the technologies and can also have computer-readable media, one or more processors, and the like.

With reference to FIG. 9, the computing environment 900 includes at least one processing unit 910 and memory 920. In FIG. 9, this most basic configuration 930 is included within a dashed line. The processing unit 910 executes computer-executable instructions and may be a real or a virtual processor. In a multi-processing system, multiple processing units execute computer-executable instructions to increase processing power. The memory 920 may be volatile memory (e.g., registers, cache, RAM), non-volatile memory (e.g., ROM, EEPROM, flash memory, etc.), or some combination of the two. The memory 920 can store software implementing any of the technologies described herein.

A computing environment may have additional features. For example, the computing environment 900 includes storage 940, one or more input devices 950, one or more output devices 960, and one or more communication connections 970. An interconnection mechanism (not shown) such as a bus, controller, or network interconnects the components of the computing environment 900. Typically, operating system software (not shown) provides an operating environment for other software executing in the computing environment 900, and coordinates activities of the components of the computing environment 900.

The storage 940 may be removable or non-removable, and includes magnetic disks, magnetic tapes or cassettes, CD-ROMs, DVDs, or any other computer-readable media which can be used to store information and which can be accessed within the computing environment 900. The storage 940 can store software containing instructions for any of the technologies described herein.

The input device(s) 950 may be a touch input device such as a keyboard, keypad, touch screen, mouse, pen, or trackball, a voice input device, a scanning device, or another device that provides input to the computing environment 900. For audio, the input device(s) 950 may be a sound card or similar device that accepts audio input in analog or digital form, or a CD-ROM reader that provides audio samples to the computing environment. The output device(s) 960 may be a display, printer, speaker, CD-writer, or another device that provides output from the computing environment 900.

The communication connection(s) 970 enable communication over a communication medium to another computing entity. The communication medium conveys information such as computer-executable instructions, audio/video or other media information, or other data in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier.

Communication media can embody computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. Communication media include wired media such as a wired network or direct-wired connection, and wireless media such as acoustic, RF, infrared and other wireless media. Combinations of any of the above can also be included within the scope of computer readable media.

The techniques herein can be described in the general context of computer-executable instructions, such as those included in program modules, being executed in a computing environment on a target real or virtual processor. Generally, program modules include routines, programs, libraries, objects, classes, components, data structures, etc., that perform particular tasks or implement particular abstract data types. The functionality of the program modules may be combined or split between program modules as desired in various embodiments. Computer-executable instructions for program modules may be executed within a local or distributed computing environment.

### Methods in Computer

### Readable Media

Any of the methods described herein can be implemented by computer-executable instructions in one or more computer-readable media (e.g., computer-readable storage media or other tangible media).

### Alternatives

The technologies from any example can be combined with the technologies described in any one or more of the other examples. In view of the many possible embodiments to which the principles of the disclosed technology may be applied, it should be recognized that the illustrated embodiments are examples of the disclosed technology and should not be taken as a limitation on the scope of the disclosed technology. Rather, the scope of the disclosed technology includes what is covered by the following claims. We therefore claim as our invention all that comes within the scope and spirit of these claims.

We claim:

1. A method of occasionally connected computing comprising:
receiving a request at a mobile computing device to perform an online business process, wherein the online business process can be performed via receipt of a message by a Web Service;
responsive to receiving the request, processing the request transparently to a user with respect to whether a network connection is available; and
sending a message to the Web Service via reliable messaging, wherein receipt of the message achieves performance of the online business process.

2. One or more computer-readable media comprising computer-executable instructions causing a computing device to perform the method of claim 1.

3. The method of claim 1 wherein sending the message comprises sending the message over a network via SOAP.

4. The method of claim 1 wherein the reliable messaging is accomplished in accordance with Web Services Reliable Messaging.

5. The method of claim 1 wherein:
processing the request comprises sending a message via an “at most once” delivery assurance profile; and
sending the message via reliable messaging comprises sending a message to the Web Service via an “exactly once” delivery assurance profile.

6. The method of claim 5 further comprising:
processing the “at most once” message delivery assurance profile via a reliable messaging infrastructure; and
processing the “exactly once” message delivery assurance profile via the reliable messaging infrastructure.

7. The method of claim 1 wherein:
a same user interface is presented for processing the online business process, regardless of whether or not the mobile computing device is connected to a network.

8. The method of claim 1 wherein:
processing the request transparently comprises:
attempting to send a query to the Web Service for an online constraint via an “at most once” message delivery assurance profile;
responsive to determining that no response to the query is available, using an offline constraint in place of the online constraint for processing the online business process; and
sending a message to the Web Service via reliable messaging comprises:
sending a message to the Web Service via an “exactly once” message delivery assurance profile.

9. The method of claim 8 further comprising:
responsive to determining that the request to perform the online business process violates the offline constraint, displaying a warning on the mobile computing device.

10. The method of claim 8 wherein the offline constraint comprises a sales quota, whereby the sales quota sets a limit on orders placed via the mobile computing device while a response is not available from the Web Service.

11. The method of claim 8 further comprising:
processing the “at most once” message delivery assurance profile via a reliable messaging infrastructure; and
processing the “exactly once” message delivery assurance profile via the reliable messaging infrastructure.

12. A method of occasionally connected computing comprising:
receiving a request at a mobile computing device to perform an online business process having an online constraint occasionally available via a Web Service;
responsive to receiving the request, attempting to send a query to the Web Service for the online constraint via an “at most once” message delivery assurance profile;
responsive to determining that no response to the query is available, using an offline constraint in place of the online constraint for processing the online business process; and
performing the online business process via sending a message to the Web Service via an “exactly once” message delivery assurance profile.

13. A mobile computing device programmed with executable instructions causing the mobile computing device to perform the method of claim 12.

14. The method of claim 12 wherein:
the offline constraint is a quota of allowable units; and
the method further comprises: upon detection of having exceeded the quota of allowable units, displaying a warning message at the mobile computing device.

15. The method of claim 12 further comprising:
processing the “at most once” message delivery assurance profile via a reliable messaging infrastructure; and
processing the “exactly once” message delivery assurance profile via the reliable messaging infrastructure.

16. The method of claim 15 wherein:
the reliable messaging infrastructure accepts the message delivery assurance profile as a parameter; and
the reliable messaging infrastructure handles details of reliable message delivery.

17. The method of claim 12 wherein:
a same user interface is presented for processing the online business process, regardless of whether or not the mobile computing device is connected to a network.

18. The method of claim 17 wherein:
a same user interface is presented indicating the online business process has been performed, regardless of whether or not the mobile computing device is connected to a network.

19. An apparatus for occasionally connected computing comprising:
means for receiving a request to perform an online business process, wherein the online business process can be performed via receipt of a message by a Web Service;
means for processing the request transparently to a user with respect to whether a network connection is available, responsive to receiving the request; and
means for sending a message to the Web Service via reliable messaging, wherein receipt of the message achieves performance of the online business process.

20. A method comprising:
via a user interface on a mobile computing device, receiving information from a user as part of processing of a business process for placing an order, wherein the information comprises information for the order;
responsive to a user interface indication by the user to place the order, querying current inventory via sending a message to a Web Service via a reliable messaging infrastructure, wherein the message is specified as having an “at most once” delivery assurance profile;
in the reliable messaging infrastructure, determining that a response is not available;
responsive to determining that a response is not available, checking whether the order has quantities exceeding inventory against an offline constraint comprising an inventory quota; and
to accomplish order processing, sending information for the order to a Web Service via a reliable messaging infrastructure, wherein the message is specified as having an “exactly once” delivery assurance profile.
